(19) United States
(12) Patent Application Publication
(10) Pub. No.: US 2016/0179716 A1
(43) Pub. Date: Jun. 23, 2016

(54) TIMER MANAGEMENT APPARATUS

(71) Applicant: Electronics and Telecommunications Research Institute, Daejeon (KR)

(72) Inventors: Baik-Song AN, Seoul (KR); Sung-Ik JUN, Daejeon (KR)

(21) Appl. No.: 14/972,359

(22) Filed: Dec. 17, 2015

(30) Foreign Application Priority Data
Dec. 17, 2014 (KR) 10-2014-0182224

(51) Int. Cl. G06F 13/24

(52) U.S. Cl. CPC G06F 13/24

(57) ABSTRACT

Disclosed herein is a timer management apparatus in which contiguous timer interrupts of an operating system run on IT equipment (desktop computers, servers, mobile devices, etc.) are coalesced and processed. Accordingly, the timer management apparatus may minimize interrupt processing load and maximize system idle time, thus improving the standby power saving effect. The proposed timer management apparatus includes a timer addition sub-module unit for adding a new timer to a timer group including one or more timers, a timer deletion sub-module unit for deleting any of the registered timers that is intended to be deleted, and a timer expiration sub-module unit for simultaneously processing timers to be expired through a single interrupt processing operation.

### CROSS REFERENCE TO RELATED APPLICATION(S)

This application claims the benefit of Korean Patent Application No. 10-2014-0182224, filed Dec. 17, 2014, which is hereby incorporated by reference in its entirety into this application.

### BACKGROUND OF THE INVENTION

1. Technical Field

The present invention generally relates to a timer management apparatus, and more particularly, to a timer management apparatus that processes interrupts of contiguous timers of an operating system run on IT equipment, such as desktop computers, servers, mobile devices, and the like.

2. Description of the Related Art

Recently, aside from the rapid increase in the popularity of mobile devices, in which battery life is an important issue, interest in power savings is now expanding to the PC and server fields due to environmental and energy-related problems. Also, the popularity of new kinds of terminals, such as smart grid terminals, has sharply increased.

Accordingly, interest in energy-saving technology related to operating systems is rapidly increasing.

Processors mounted in the latest IT devices, such as desktops, servers, mobile devices, and the like, support a low power idle state to reduce the power and energy that is consumed while a system is idle. This is described and managed as the C-state of a processor.

The C-state is defined in an Advanced Configuration and Power Interface (ACPI) standard. For higher standby power saving effects, a vendor-specific C-state may be additionally defined and operated. By using this, idle states may be managed on a level basis in accordance with the system conditions of an IT device.

To minimize the standby power of a system, it is necessary to drive the system into the highest C-state, and to this end, it is important to maximize the system idle time. However, interrupts caused by various timer events periodically wake up the system and interfere with maintenance of the idle state.

When the number of event occurrences is greatly increased due to an increase in system load, interrupts sporadically occur to process the large number of timer events, and system idle time is disrupted. This may result in a waste of standby power, and handling many interrupts may create unnecessary system load.

FIG. 1 is a view illustrating the system structure of a general IT device. An operating system kernel 10 is in the upper layer of the hardware comprising a CPU 1, a memory 2, a storage system 3, a network system 4, and the like. The operating system kernel 10 manages system resources including hardware through device managers 11, 12, 13, and 14, and provides services to user application programs 21, 22, 23, and 24 in the upper layer.

The user application programs 21, 22, 23, and 24 may be understood to include system-level libraries and middleware. The user application programs 21, 22, 23, and 24 define and implement a set of functions for providing users with immediate services, and communicate with the operating system kernel 10 in the lower layer through system calls and predefined system interfaces.

A module that manages and executes a timer required by a system (that is, a timer management module 15) is included within the operating system kernel 10. In common with other kernel functions, the operating system kernel may communicate with user application programs 21, 22, 23, and 24, which require timer functions, through system call interfaces. Also, the device managers 11, 12, 13, and 14 in the operating system kernel 10 operate using a timer function through the timer management module 15.

FIG. 2 is a view for describing how the timer management module 15 of FIG. 1 is managed. When a timer registered in a system expires, timers 15a, 15b, and 15c each individually generate and process interrupts (interrupt 1, interrupt 2, and interrupt 3).

As mentioned above, one problem with this existing method is that a large interrupt load is generated when the number of timers to be processed increases concomitant with an increase in system load. As a result, in addition to the increased load, the opportunity to save power during system idling is lost, thus wasting energy.

Consequently, the problems with the conventional art are as described below.

When many timers are generated due to an increase in system load, interrupts for processing the timers are simultaneously generated, thus the system load necessary for handling interrupts is additionally increased. The occurrence of multiple interrupts frequently moves the system from an idle state to an active state and reduces the effect of standby power cutoff that may be obtained by putting the system and internal devices into a standby mode during the idle state.

To reduce the timer interrupt load, coalescing is necessary. For timer coalescing, the expiration time of a timer must be changed. However, it is difficult for people who are not a corresponding program developer to accurately predict negative effects on the system that may occur due to the change of the expiration time. Therefore, to prevent such a difficulty, the conventional timer management technique thoroughly complies with the timer expiration time, and thus it is difficult to expect a power savings effect via the timer coalescing.

As a related conventional art, U.S. Patent Publication No. 2010-0077394 (entitled “Coalescing periodic timer expiration in guest operating systems in a virtualized environment”) discloses techniques whereby a single physical timer on a physical machine is processed by coalescing virtual timers of a guest OS in a virtualized environment.

As another related conventional art, U.S. Pat. No. 8,478,924 (entitled “Interrupt coalescing for outstanding input/output completions”) discloses a method in which, by coalescing I/O interrupts, the interrupt load that occurs during high I/O rates is reduced.

### SUMMARY OF THE INVENTION

Accordingly, the present invention has been made keeping in mind the above problems occurring in the conventional art, and an object of the present invention is to provide a timer management apparatus in which contiguous timer interrupts of an operating system run on IT equipment (desktop computers, servers, mobile devices, etc) are coalesced and processed. Therefore, the timer management apparatus may minimize the interrupt processing load and maximize system idling time, thus improving standby power saving effects.

To accomplish the above object, a timer management apparatus according to preferred embodiment of the present invention includes: a timer addition sub-module unit for adding a new timer to a timer group including one or more timers; a timer deletion sub-module unit for deleting a timer intended to be deleted among registered timers; and a timer expiration sub-module unit for simultaneously processing timers to be expired by a single interrupt processing operation.

The one or more timers may individually have a permissible expiration time modification range.

The timer group may have a representative timer expiration time that is applicable to all the timers included in the timer group.

Between the permissible expiration time modification range of the timer and the representative timer expiration time of the corresponding timer group, a common value may be present.

The timer expiration sub-module unit may search for a timer group to be expired, and while sequentially executing timers included in the found timer group, may delete the timers from the timer group.

The timer expiration sub-module unit may search for the timer group to be expired based on the representative timer expiration time for each timer group.

After executing all the timers included in the found timer group, the timer expiration sub-module unit may delete the expired corresponding timer group.

The timer group includes one or more timer groups, and the timer addition sub-module unit determines whether a timer group to which a new timer is capable of being added exists among the timer groups, and may add the new timer to the timer group to which the new timer is capable of being added.

The timer addition sub-module unit may determine whether a timer group to which the new timer is capable of being added exists, depending on whether a common value is present between a representative timer expiration time for each timer group and a permissible expiration time modification range of the new timer.

The timer addition sub-module unit may create a new timer group when there is no timer group to which the new timer is capable of being added, and may add the new timer to the new timer group.

The representative timer expiration time of the new timer group may be set as the expiration time of the added new timer.

The timer deletion sub-module unit searches for a timer group including a timer intended to be deleted, and may delete the timer from the found timer group.

When the timer intended to be deleted is the only timer in the found timer group, the timer deletion sub-module unit deletes both the corresponding timer and the timer group.

According to the present invention configured as described above, as multiple timers are coalesced and the multiple timers are simultaneously processed through a single interrupt, the load caused by timer interrupt processing may be reduced, and system standby power savings may be more effectively achieved.

Also, because a program developer specifies a permissible modification range for a timer expiration time, the effects on the corresponding programs caused by changing the expiration time may be minimized, and the timer coalescing effect may be maximized.

Also, by providing program interfaces for supporting a timer coalescing function, available both at the user application program level and at the level of device managers within an operating system kernel, the timer coalescing function may be widely used at both the user application level and the kernel level, thus maximizing the effect of reduction of load and standby power.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating the system structure of a general IT device;

FIG. 2 is a view describing how the timer management module illustrated in FIG. 1 is managed;

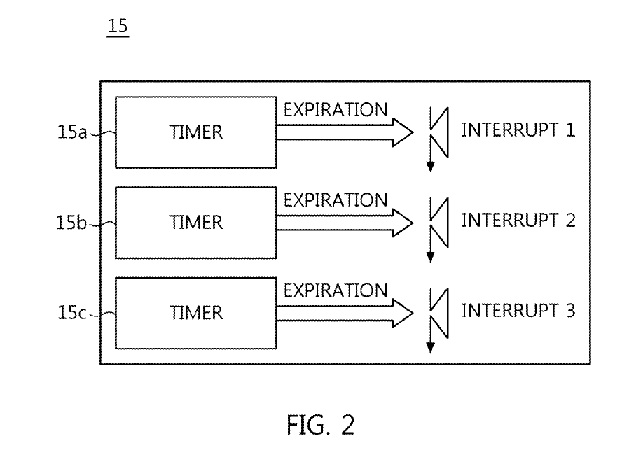

FIG. 3 is a concept diagram of a timer management apparatus according to an embodiment of the present invention;

FIG. 4 is an internal block diagram of a timer management apparatus according to an embodiment of the present invention;

FIG. 5 is a flowchart describing the operation algorithm of a timer addition sub-module unit, illustrated in FIG. 4;

FIG. 6 is a flowchart describing the operation algorithm of a timer deletion sub-module unit, illustrated in FIG. 4;

FIG. 7 is a flowchart describing the operation algorithm of a timer expiration sub-module unit, illustrated in FIG. 4;

FIG. 8 is a graph showing the variation in the number of interrupt occurrences according to an embodiment of the present invention; and

FIG. 9 is a view explaining the effect of a timer coalescing function according to an embodiment of the present invention.

### DESCRIPTION OF THE PREFERRED EMBODIMENTS

The present invention may be variously changed, and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as having ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings, and repeated descriptions of the same components will be omitted.

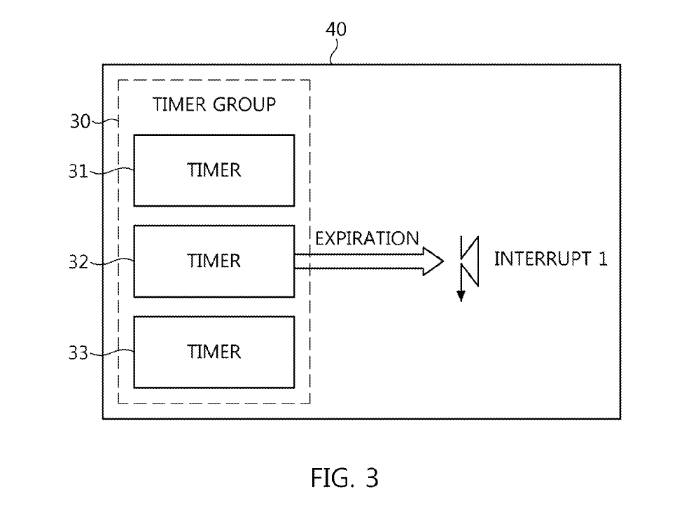

FIG. 3 is a concept diagram of a timer management apparatus according to an embodiment of the present invention.

A timer management apparatus 40 according to an embodiment of the present invention adopts a method in which multiple timers 31, 32, and 33 are grouped, and at the expiration of the timers, the multiple timers 31, 32, and 33 are simultaneously processed through a single interrupt processing operation. Here, the group of multiple timers is called a timer group 30. Multiple timer groups 30 may be present in the timer management apparatus 40.

As described above, the method in which multiple timers 31, 32, and 33 are grouped and the multiple timers are simultaneously processed through a single interrupt processing operation upon the expiration of the timers may reduce the load caused by the occurrence of multiple interrupts, and may minimize the interference caused by interrupts. Accordingly, by facilitating entry into a lower power mode when a system is idle, standby power may be effectively reduced.

In FIG. 3, timers 31, 32, and 33 each have a permissible range within which the timer expiration time may be modified. Also, a representative timer expiration time that is applicable to all the timers 31, 32, and 33 included in a single timer group 30 is required. The intersection (a common value) of the expiration time modification ranges of the timers 31, 32, and 33 may be taken as the representative timer expiration time.

In other words, multiple timers whose expiration time modification ranges intersect may form a single timer group. That is, a common value may exist that falls within the permissible modification range of the timer expiration time and the representative timer expiration time of the corresponding timer group.

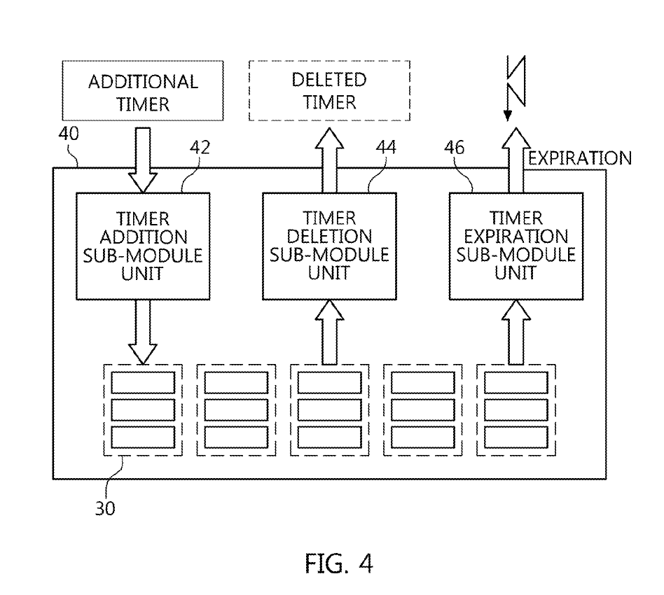

FIG. 4 is an internal block diagram of a timer management apparatus according to an embodiment of the present invention.

A timer management apparatus 40 according to an embodiment of the present invention includes a timer addition sub-module unit 42, a timer deletion sub-module unit 44, and a timer expiration sub-module unit 46.

Each of the sub-module units 42, 44, and 46 provides management functions for individual timers and a timer group 30.

When a new timer is registered, the timer addition sub-module unit 42 searches for a combinable timer group among existing timer groups, and may then register the new timer.

The timer deletion sub-module unit 44 may delete any of the registered timers that needs to be canceled and/or deleted.

The timer expiration sub-module unit 46 may simultaneously process coalesced timers upon the expiration of the timers.

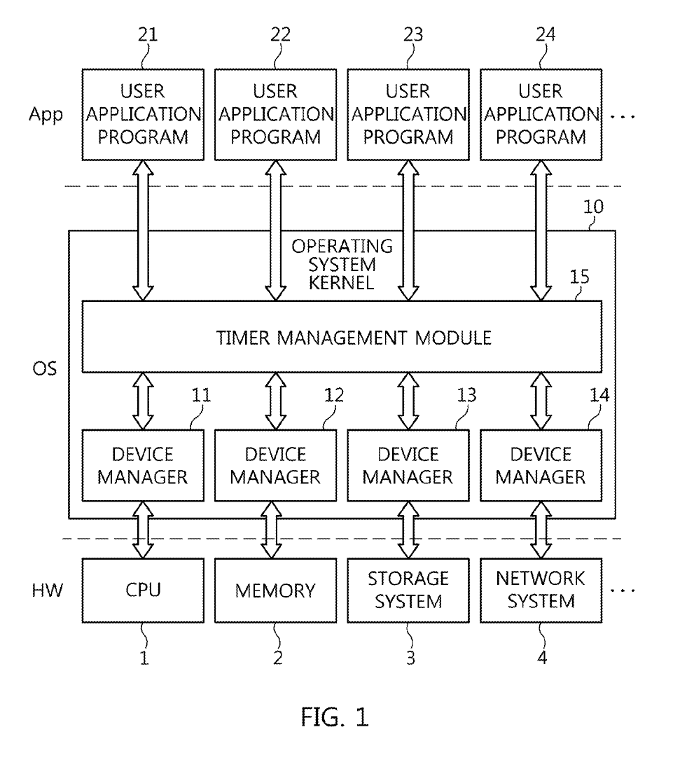

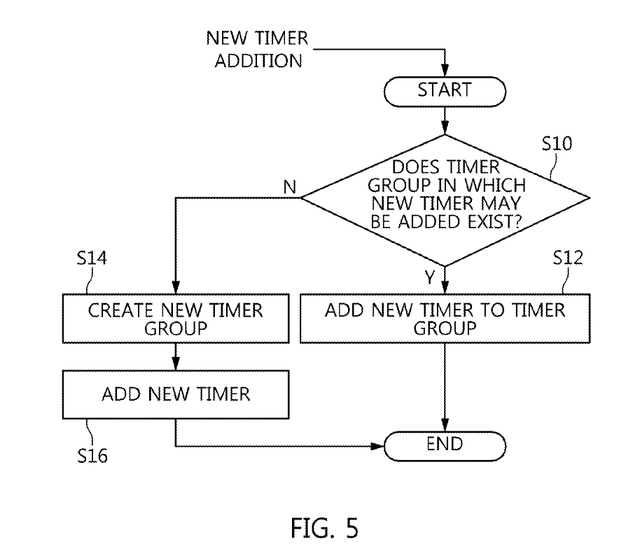

FIG. 5 is a flowchart describing the operation algorithm of the timer addition sub-module unit illustrated in FIG. 4. A timer management apparatus 40 according to an embodiment of the present invention may be applied to the system structure of a general IT device illustrated in FIG. 1.

First, to maximize the effect of timer coalescing, the expiration time of a timer must be changeable. To this end, the permissible range within which the expiration time of a timer may be changed needs to be defined for each of the timers 31, 32, and 33. This information is defined by user application programs 21, 22, 23, and 24, which actually generate and use timers, or by device managers 11, 12, 13, and 14 within an operating system kernel 10, and is then transmitted to a timer management apparatus 40.

For example, when a timer expiration time is set as the time 100 ms after the current time and the permissible modification range is specified as 15 ms, the valid expiration time modification range of the timer is 85 to 115 ms based on the current time.

When a request is received for the addition of a new timer, first, the timer addition sub-module unit 42 determines whether there is a timer group to which the new timer may be added at step S10. In other words, it is determined at step S10 whether there is an existing timer group into which the added timer may be coalesced. This may be determined depending on whether a common value (an intersection) is present between the representative timer expiration time for each timer group and the expiration time modification range of the timer to be added. In the above example, if there is a timer group for which the representative timer expiration time is 95 ms, a timer having an expiration time modification range from 85 to 115 ms may be coalesced into the timer group. Methods for searching multiple timer groups to check the possibility of coalescing may vary depending on the data structure used for timer group management. When a timer group is managed based on a list, a search algorithm based on a loop may be used, and when the timer group is managed using a tree structure, a search algorithm based on the corresponding tree may be used.

As a result of the determination, when it is determined that a timer group to which the new timer may be added exists (“Y” at step S10), the timer addition sub-module unit 42 adds the new timer to the corresponding timer group at step S12. In other words, when there is an existing timer group that can be combined with the new timer, the new timer is coalesced into the existing timer group and the addition operation is terminated. Methods for managing timers included in a timer group may also vary depending on the method whereby the corresponding timer group is implemented. After a timer is added to a timer group, it is not necessary to additionally adjust the representative timer expiration time of the timer group. This is because, when the possibility of coalescing was checked, it was already confirmed that a common value is present between the permissible modification range of the expiration time of the new timer and the representative timer expiration time of the current timer group. It would be possible to perform optimization by reducing the change in the expiration time of each timer by adjusting the representative timer expiration time, but it would be inconvenient because whether the adjusted value is beyond the permissible range of the existing timers would additionally need to be checked.

On the other hand, when it is determined that no timer group to which the new timer may be added exists (“N” at step S10), the timer addition sub-module unit 42 creates a new timer group at step S14. Then, the timer addition sub-module unit 42 adds the new timer to the new timer group at step S16. In other words, when there is no existing timer group that can be combined with the new timer, an additional timer group is newly created, the new timer is added to the new timer group, and the addition operation is terminated. In this case, the representative timer expiration time of the newly created timer group may be set as the expiration time of the timer newly added to the timer group. The newly created timer group is managed and maintained according to a data structure used in timer group management.

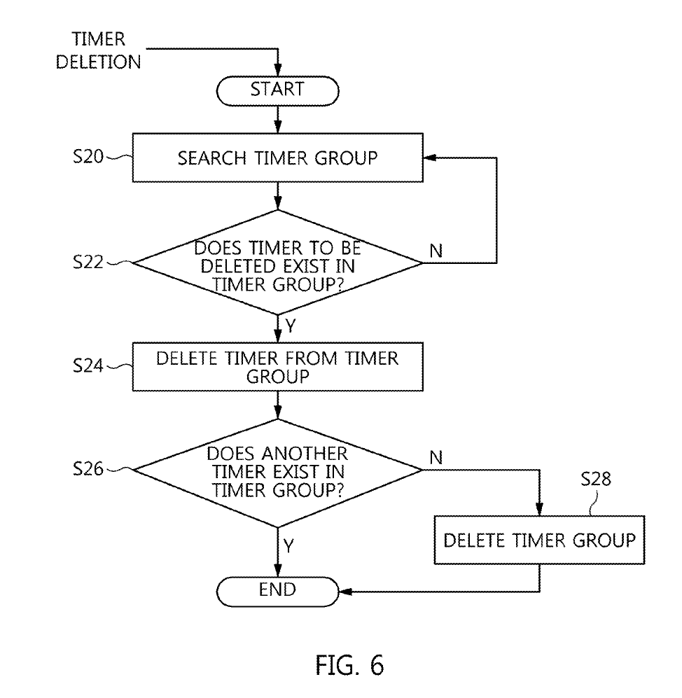

FIG. 6 is a flowchart describing the operation algorithm of a timer deletion sub-module unit 44 illustrated in FIG. 4.

When it is necessary to delete a timer, a timer deletion sub-module unit 44 searches in order to determine which timer group the timer to be deleted is included in at step S20. In this case, the search method is identical to the search method that is used for searching for a combinable timer group in the timer addition algorithm, and may vary depending on the data structure used in the timer group management.

When the timer group in which the timer to be deleted is included is found (“Y” at step S22), the timer deletion sub-module unit 44 deletes the corresponding timer from the corresponding timer group at step S24.

On the other hand, when the timer to be deleted is the only timer in the corresponding timer group, in other words, when there would be no timer remaining in the corresponding timer group after deletion of the timer (“N” at step S26), the timer deletion sub-module unit 44 deletes both the timer and the timer group at step S28. Then, if necessary, the timer deletion sub-module unit 44 may update a data structure for timer group management after deletion of the timer group.

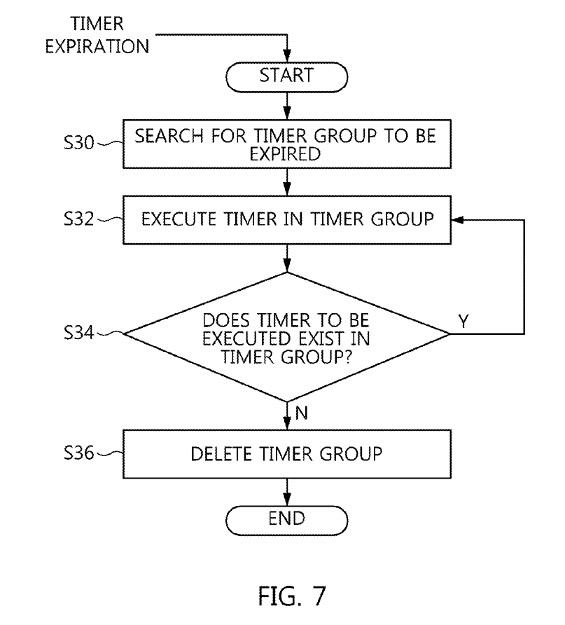

FIG. 7 is a flowchart describing the operation algorithm of a timer expiration sub-module unit 46 illustrated in FIG. 4.

In a timer coalescing function, because multiple timers are included in a single timer group and a representative timer expiration time is set for each timer group, the timer expiration is based on the representative timer expiration time for each timer group. At this time, all of the timers included in the corresponding timer group are expired and executed together.

First, the timer expiration sub-module unit 46 finds a timer group to be expired by searching at step S30. In this case, the search method is the same as the search method used in the timer addition and deletion algorithms.

Then, while sequentially executing timers included in the found timer group, the timer expiration sub-module unit 46 deletes the timers from the timer group at steps S32 and S34.

After all the timers in the timer group have executed and there is no timer to be executed (“N” at step S34), the timer expiration sub-module unit 46 deletes the expired timer group at step S36. Then, if necessary, the timer expiration sub-module unit 46 may update the data structure for the timer group management.

To improve the effect of the above-described timer coalescing, a permissible modification range of the expiration time should be specified for each timer, which requires modification of the existing timer-setting interface. Generally, user application programs 21, 22, 23, and 24 use system call interfaces to communicate with a timer management module within an operating system kernel 10.

Accordingly, for timer coalescing, an embodiment of the present invention defines a new interface in which an expiration time modification range may be set as an additional parameter of the existing timer-related system call interface. When a value for the expiration time modification range is omitted, the modification range value may be set as a predefined value. As an example, currently, the Linux operation system provides setitimer( ) and timer_settime( ) as timer-related system calls, and a new interface for setting the modification range of a timer expiration time (tolerable_time) may be defined as shown in the following Table 1.

TABLE 1
int setitimer_coalescable(int which, const struct itimerval *new_value,
struct itimerval
*old_value, unsigned long tolerable_time);
int timer_settime_coalescable(timer_t timerid, int flags, const
struct itimerspec
*new_value, struct itimerspec *old_value, unsigned long
tolerable_time);

Also, for timer-related interfaces available in an operating system kernel, such as device managers, a new programming interface may be defined in which a value for the modification range of a timer expiration time is added as a function parameter, similar to the above-mentioned system call interfaces.

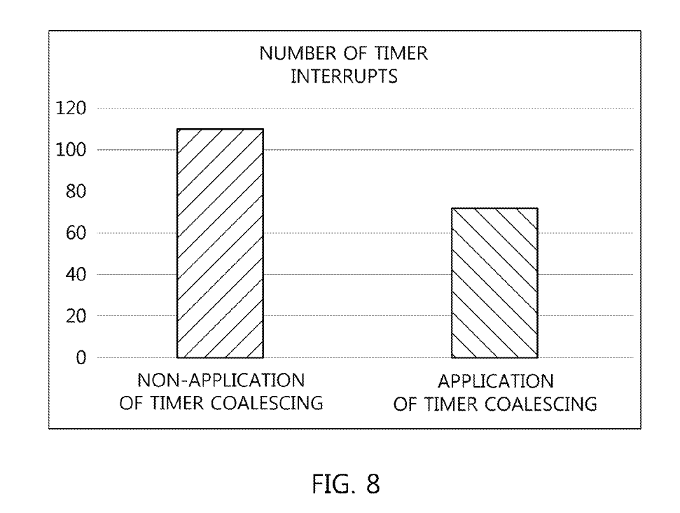

FIG. 8 is a graph showing variation in the number of interrupt occurrences according to an embodiment of the present invention.

To verify the effect according to the embodiment of the present invention, the number of interrupt occurrences when a timer coalescing function is applied is measured by an actual program, and as a result, 34.54% of the reduction effect is verified, as shown in FIG. 8. The effect may differ depending on the program properties, but the result shows the method is certainly effective in reducing loads that frequently use timers.

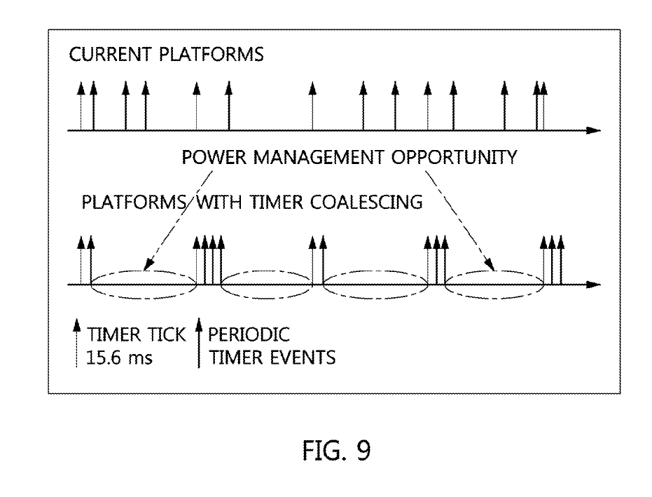

FIG. 9 is a view explaining the effect of a timer coalescing function according to an embodiment of the present invention.

A timer coalescing function is one of various methods for minimizing interrupt occurrences caused by a timer, and is a method for extending the system idle time by synchronizing the expiration processing of multiple timers.

FIG. 9 shows the effect of the timer coalescing function, and the timer coalescing function may extend the idle time by merging contiguous timer events and by processing the merged event. Also, by processing multiple timers through a single interrupt event, the timer coalescing function is advantageous in terms of reducing the load of interrupt processing on the system.

As described above, optimal embodiments of the present invention have been disclosed in the drawings and the specification. Although specific terms have been used in the present specification, these are merely intended to describe the present invention, and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A timer management apparatus, comprising:
a timer addition sub-module unit for adding a new timer to a timer group including one or more timers;
a timer deletion sub-module unit for deleting a timer intended to be deleted among registered timers; and
a timer expiration sub-module unit for simultaneously processing timers to be expired by a single interrupt processing operation.

2. The timer management apparatus of claim 1, wherein the one or more timers individually have a permissible expiration time modification range.

3. The timer management apparatus of claim 2, wherein the timer group has a representative timer expiration time that is applicable to all the timers included in the timer group.

4. The timer management apparatus of claim 3, wherein the permissible expiration time modification range of the timer and the representative timer expiration time of the corresponding timer group have a common value therebetween.

5. The timer management apparatus of claim 1, wherein the timer expiration sub-module unit searches for a timer group to be expired, and while sequentially executing timers included in the found timer group, deletes the timers from the timer group.

6. The timer management apparatus of claim 5, wherein the timer expiration sub-module unit searches for the timer group to be expired based on the representative timer expiration time for each timer group.

7. The timer management apparatus of claim 5, wherein after executing all the timers included in the found timer group, the timer expiration sub-module unit deletes the expired corresponding timer group.

8. The timer management apparatus of claim 1, wherein:
the timer group includes one or more timer groups, and
the timer addition sub-module unit determines whether a timer group to which a new timer is capable of being added exists among the timer groups, and adds the new timer to the timer group to which the new timer is capable of being added.

9. The timer management apparatus of claim 8, wherein the timer addition sub-module unit determines whether a timer group to which the new timer is capable of being added exists, depending on whether a common value is present between a representative timer expiration time for each timer group and a permissible expiration time modification range of the new timer.

10. The timer management apparatus of claim 8, wherein the timer addition sub-module unit creates a new timer group when there is no timer group to which the new timer is capable of being added, and adds the new timer to the new timer group.

11. The timer management apparatus of claim 10, wherein the representative timer expiration time of the new timer group is set as the expiration time of the added new timer.

12. The timer management apparatus of claim 1, wherein the timer deletion sub-module unit searches for a timer group including a timer intended to be deleted, and deletes the timer from the found timer group.

13. The timer management apparatus of claim 12, wherein, when the timer intended to be deleted is the only timer in the found timer group, the timer deletion sub-module unit deletes both the corresponding timer and the timer group.
